(19) United States
(12) Patent Application Publication
(10) Pub. No.: US 2012/0127069 A1
(43) Pub. Date: May 24, 2012

(54) Input Panel on a Display Device

(76) Inventors: Soma Sundaram Santhiveeran, Fremont, CA (US); Juliano Godinho Varaschin De Moraes, Porto Alegre Rio Grande do Sul (BR); Mark C. Solomon, San Jose, CA (US)

(21) Appl. No.: 12/953,885

(22) Filed: Nov. 24, 2010

(51) Int. Cl. G09G 5/00

(52) U.S. Cl. 345/156

(57) ABSTRACT

A device including a sensor to detect a holding position of a user of the device, an orientation sensor to detect an orientation of the device, and a controller to render an input panel on at least one location of a display device based on the holding position of the user and the orientation of the device.

### BACKGROUND

When rendering a keyboard or an input panel for a user to interact with, a device can display the keyboard or input panel on a predetermined position of a display device. Alternatively, if the device includes an accelerometer, the accelerometer can detect an orientation of the device and the device can proceed to display the keyboard or the input panel at another predetermined position of the display device based on the detected orientation of the device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device coupled to a sensor, an orientation sensor, and a display device according to an embodiment.

FIG. 2A and FIG. 2B illustrate one or more sensors coupled to a device at one or more positions according to an embodiment.

FIG. 3A and FIG. 3B block diagrams of a controller and/or an input application determining where to render on a display device to render an input panel according to an embodiment.

FIG. 4A, FIG. 4B, and FIG. 4C illustrate an input panel being rendered at one or more locations of a display device based on a holding position of a user and an orientation of a device according to an embodiment.

FIG. 5 illustrates an input application on a device and the input application stored on a removable medium being accessed by the device according to an embodiment.

FIG. 6 is a flow chart illustrating a method for displaying an input panel according to an embodiment.

FIG. 7 is a flow chart illustrating a method for displaying an input panel according to another embodiment.

### DETAILED DESCRIPTION

In response to a user interacting with a device, one or more sensors of the device can detect a holding position of a user of the device. As the user is holding the device, an orientation sensor of the device can detect an orientation of the device. In response, a controller can render an input panel on one or more locations of a display device based on the holding position of the user and the detected orientation of the device. By rendering the input panel at one or more locations in response to the detected hand position of the user and the detected orientation of the device, a user friendly experience can be created for the user by properly positioning the input panel at easily accessible locations on the display device.

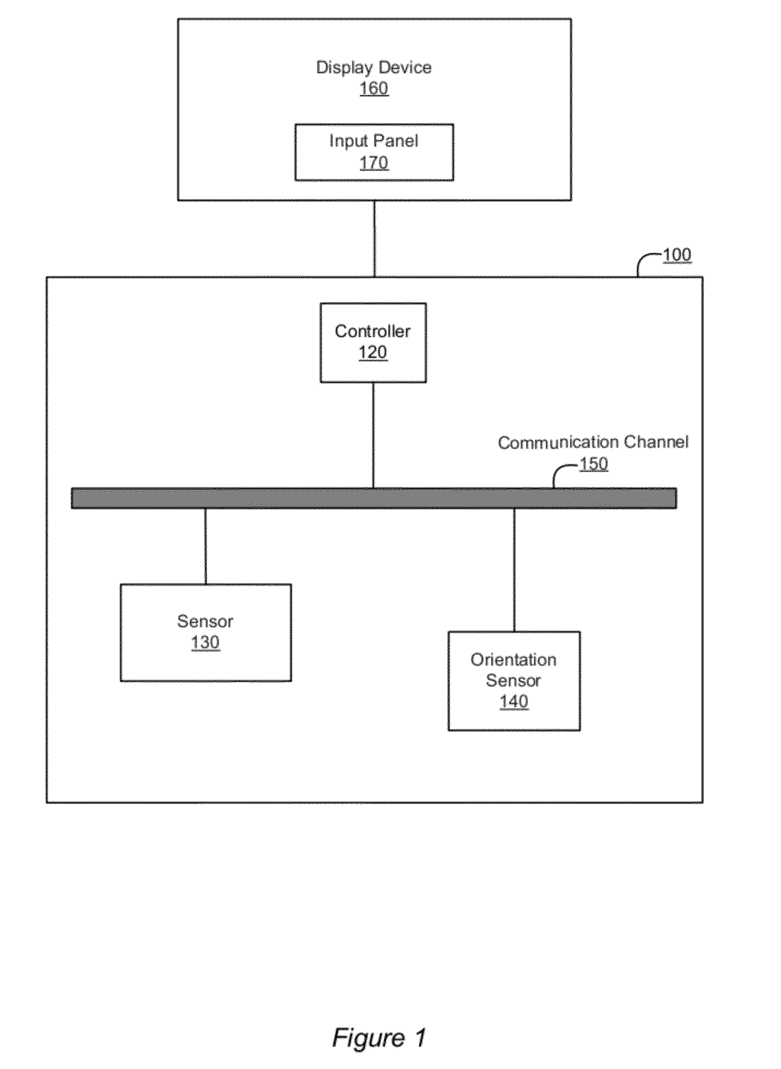

FIG. 1 illustrates a device 100 coupled to one or more sensors 130, an orientation sensor 140, and a display device 160 according to an embodiment. In one embodiment, the device 100 is or includes a desktop, a laptop, a notebook, a tablet, a netbook, an all-in-one system, and/or the like. In another embodiment, the device 100 is a cellular device, a PDA, an E-Reader, and/or any additional computing device which can include one or more sensors 130.

As illustrated in FIG. 1, the device 100 includes a controller 120, one or more sensors 130, an orientation sensor 140 and a communication channel 150 for the device 100 and/or one or more components of the device 100 to communicate with one another. Additionally, as illustrated in FIG. 1, the device 100 is coupled to a display device 160 configured to render an input panel 170. In another embodiment, the device 100 includes a storage device and the storage device includes an input application. In other embodiments, the device 100 includes additional components and/or is coupled to additional components in addition to and/or in lieu of those noted above and illustrated in FIG. 1.

As noted above, the device 100 includes a controller 120. The controller 120 can send data and/or instructions to the components of the device 100, such as one or more of the sensors 130, the orientation sensor 140, the display device 160, and/or the input application. Additionally, the controller 120 can receive data and/or instructions from components of the device 100, such as one or more of the sensors 130, the orientation sensor 140, the display device 160, and/or the input application.

The input application is an application which can be utilized in conjunction with the controller 120 to render an input panel 170 for display on one or more locations of the display device 160. For the purposes of this application, an input panel 170 can be an interactive panel displayed on one or more locations of the display device 160 which the user can access when entering one or more inputs on the device 100. The display device 160 can be an output device configured to display the input panel 170 and/or one or more images or videos.

When determining where to render the input panel 170, one or more sensors 130 of the device 100 can initially detect a holding position of a user of the device 100. For the purposes of this application, a sensor 130 is a component of the device 100 configured to detect the holding position of the user if the user is accessing the device 100. A user can be any person which can access the device 100 by holding the device 100 in one or more positions.

A holding position of the user can include to a first hand position of the user. In another embodiment, the holding position of the user can additionally include a second hand position of the user. When detecting a holding position of the user, one or more sensors 130 can detect where on the device 100 the user's first hand is holding the device 100. In another embodiment, one or more of the sensors 130 can additionally detect where on the device 100 the user's second hand is holding the device 100.

Additionally, an orientation sensor 140 of the device 100 can be utilized in conjunction with the controller 120 and/or the input application to detect an orientation of the device 100 while one or more sensors 130 detect a holding position of the user and/or after the holding position of the user has been detected. An orientation sensor 140 can be a hardware component of the device 100 configured to detect an orientation of the device 100 based on the holding position of the user. In one embodiment, the orientation sensor 140 can include a gyroscope and/or an accelerometer. For the purposes of this application, the orientation of the device 100 corresponds to whether the device 100 is oriented in a landscape direction or a portrait direction relative to one or more axes.

Using the detected holding position of the user and the detected orientation of the device 100, the controller 120 and/or the input application can proceed to render the input panel 170 for display on one or more locations of the display device 160. The input application can be firmware which is embedded onto the controller 120, the device 100, and/or the storage device of the device 100. In another embodiment, the input application is an application or an operating system executable by the controller 120 and stored on the device 100 within ROM or on the storage device accessible by the device 100. In other embodiments, the input application is stored on a computer readable medium readable and accessible by the device 100 or the storage device from a different location.

Additionally, in one embodiment, the storage device is included in the device 100. In other embodiments, the storage device is not included in the device 100, but is accessible to the device 100 utilizing a network interface included in the device 100. The network interface can be a wired or wireless network interface card, a Bluetooth interface, and/or an infra red interface. In other embodiments, the storage device can be configured to couple to one or more ports or interfaces on the device 100 wirelessly or through a wired connection.

In a further embodiment, the input application is stored and/or accessed through a server coupled through a local area network or a wide area network. The input application communicates with devices and/or components coupled to the device 100 physically or wirelessly through a communication bus 150 included in or attached to the device 100. In one embodiment the communication bus 150 is a memory bus. In other embodiments, the communication bus 150 is a data bus.

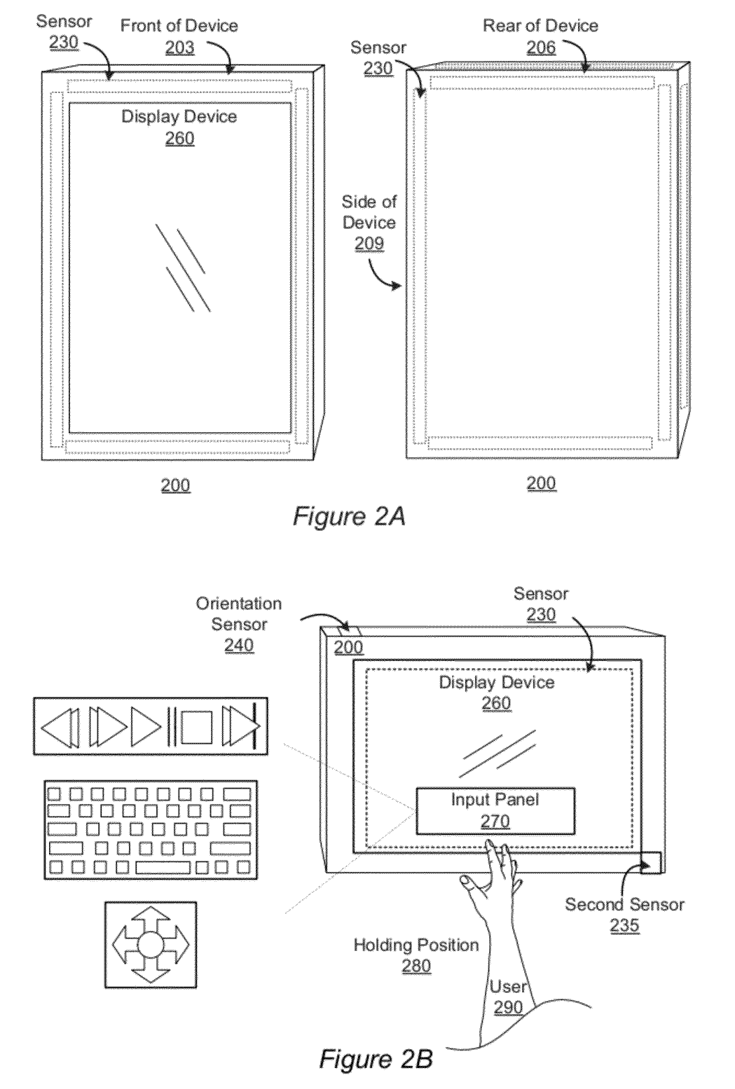

FIG. 2A and FIG. 2B illustrate one or more sensors 230 coupled to a device 200 at one or more positions according to an embodiment. As noted above, one or more sensors 230 can be hardware components configured to detect a holding position of a user. In one embodiment, one or more of the sensors 230 can include a touch sensor and/or a touch panel. In another embodiment, one or more sensors 230 can include a camera, an infra-red device, a proximity device, and/or any additional component coupled to the device 200 and configured to detect and/or identify a holding position of a user of the device 200.

As illustrated in FIG. 2A, one or more of the sensors 230 can be coupled to a front surface 203 of the device 200 and positioned at one or more locations around a perimeter of the front surface 203. In one embodiment, a single sensor 230 can wrap around the perimeter of the front surface 203. Alternatively, the device 200 can include more than one sensor 230 positioned at one or more locations around the front surface 203 of the device 200.

In another embodiment, one or more of the sensors 230 can be coupled to additional locations on the device 200, such as on one or more locations on a rear surface 206 of the device 200 and/or on one or more locations around a side surface 209 of the device 200. In other embodiments, as illustrated in FIG. 2B, one or more of the sensors 230 can be included or integrated as part of a display device 260 coupled to the device 200.

One or more of the sensors 230 can communicate with one another, her, with a controller, and/or with an input application of the device 200 when detecting a holding position 280 of a user 290. When detecting the holding position 280, a sensor 230 can detect where on the device 200 the user 290 is holding the device 200. In one embodiment, the sensor 230 can detect a position of the user's 290 first hand holding the device 200. In another embodiment, the sensor 230 can further detect a position of the user's 290 second hand holding the device 200.

For the purposes of this application, the user 290 can hold the device 200 with one or more palms of the user 290. In another embodiment, the user 290 can hold the device 200 using an arm of the user 290 as a support for the device 200 and/or by grasping the device 200 with one or more fingers of the user 290. In other embodiments, the user 290 can hold the device 200 using additional methods in addition to and/or in lieu of those noted above.

When detecting the position of the first hand and/or the second hand, a sensor 230 can detect a location of one or more palms of the user 290. In one embodiment, when detecting the position of the first hand and/or the second hand, the sensor 230 can detect a location of side by side fingers from a hand of the user 290. In another embodiment, the sensor 230 can detect a location of one or more arms of the user 290. In other embodiments, the sensor 230, the controller, and/or the input application can further use image capturing technology, touch technology, and/or time of flight technology to determine the position of the user's 290 first hand and/or second hand.

As noted above and as illustrated in FIG. 2B, the device 200 can further include an orientation sensor 240 configured to detect an orientation of the device 200. The orientation sensor 240 can be a hardware component of the device 200 configured to detect and/or identify an orientation of the device 200 relative to one or more axes. In one embodiment, the orientation sensor 240 can include a gyroscope and/or an accelerometer to detect a tilt, rotation, and/or movement of the device 200 along or around one or more axes. One or more of the axes can include an X axis, a Y axis, and/or a Z axis. When detecting the orientation of the device 200, the orientation sensor 240 can detect whether the device 200 is being held in a portrait orientation or in a landscape orientation based on the hand position 280 of the user 290.

As illustrated in the present embodiment, one or more of the sensors 230 has detected the holding position 280 of the user 290 to include a fist hand holding a bottom center location of the device 200. Further, the orientation sensor 240 has detected that the device 200 is being held in a landscape orientation. In response to detecting the hand position 280 and/or the orientation of the device 200, the controller and/or an input application of the device 200 can proceed to render an input panel 270 for display on one or more locations on the display device 260. In one embodiment, rendering the input panel 270 includes orienting the input panel 270 based on the detected orientation of the device 200.

The display device 260 can be an output device configured to render one or more images and/or videos. One or more images and/or videos can include a user interface and/or the input panel 270. In one embodiment, the display device 260 can be a LCD (liquid crystal display), a LED (light emitting diode) display, a CRT (cathode ray tube) display, a plasma display, a projector and/or any additional device configured to display the input panel 270.

As noted above and as illustrated in FIG. 2B, the input panel 270 can be an interactive panel which the user 290 can access when entering one or more inputs on the device 200. In one embodiment, the input panel 270 can include an alphanumeric keyboard, a navigation panel, an application control panel, and/or a media player panel. The application control panel can be or include a game pad or navigation. In other embodiments, the input panel 270 can include additional interactive panels which the user 290 can access in addition to and/or in lieu of those noted above.

Once the input panel 270 has been rendered, the user 290 can access the input panel 270 to enter one or more inputs for the device 200 to process. The user 290 can enter one or more inputs with the input panel 270 by touching the input panel 270 with a hand and/or finger of the user 290. In another embodiment, the user 290 can access the input panel 270 using one or more objects, such as a stylus.

When detecting an input, one or more of the sensors 230 can detect the user 290 accessing the input panel 270 and detect where on the input panel 270 the user 290 is accessing. In another embodiment, the device 200 can include one or more second sensors 235. A second sensor 235 can be a touch sensor, a touch panel, a camera, an infra-red device, a proximity device, and/or any additional component configured to detect the user 290 accessing the input panel 270. In response to detecting an input, a sensor 230 and/or a second sensor 235 can notify the controller and/or the input application. The controller and/or the input application can then identify one or more commands or instructions corresponding to the input.

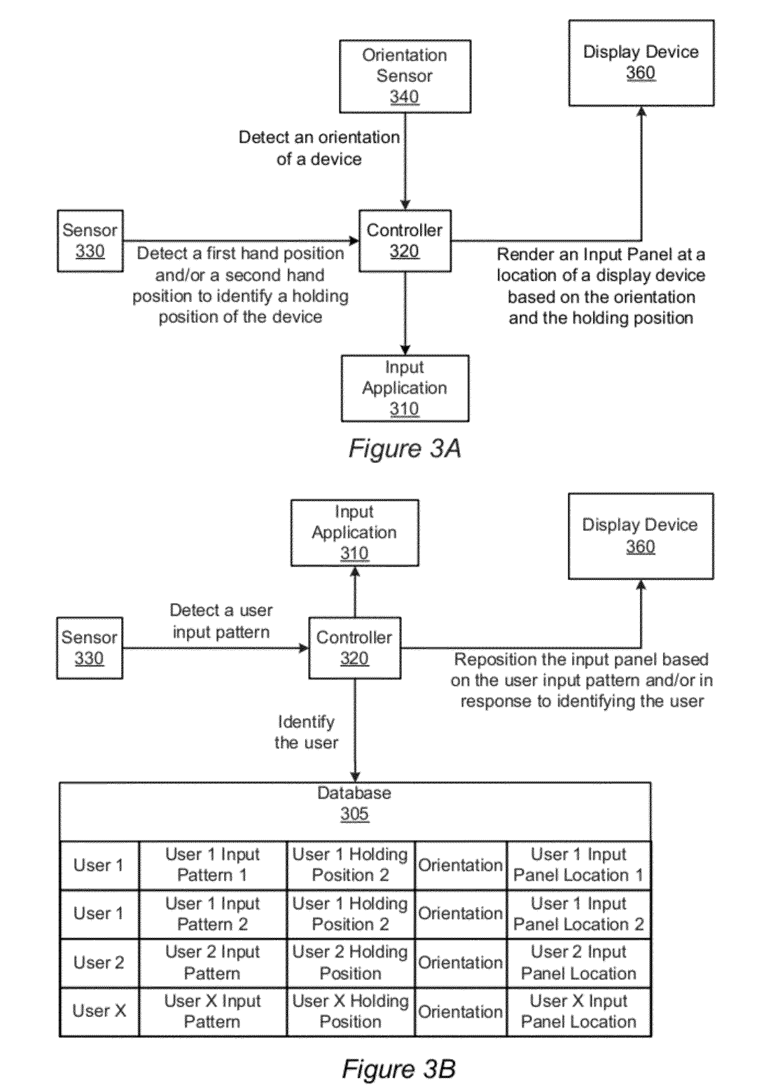

FIG. 3A and FIG. 3B block diagrams of an input application 310 determining where on a display device 360 to render an input panel according to an embodiment. As noted above, a holding position of the user can be detected by a sensor 330 of the device and the holding position can include a first hand position and/or a second hand position of the user holding the device. In one embodiment, the sensor 330 can continuously detect the holding position of the user in response to the user accessing the device. In another embodiment, the sensor 330 can periodically and/or in response to instruction by a controller 320 and/or en input application 310 detect the holding position of the user.

As illustrated in the present embodiment, the sensor 330 has detected a user accessing the device and the sensor 330 has detected a holding position of the user. In response, the controller 320 and/or the input application 310 can access the data and/or information from the sensor 330 and proceed identify where on the device a first hand of the user and/or a second hand of the user is holding the device to identify the holding position of the user. Further, as illustrated in FIG. 3A, an orientation sensor 340 of the device has detected an orientation of the device. As noted above, the orientation sensor 330 can detect the orientation of the device based on the holding position of the user.

Using the detected holding position of the user and the detected orientation of the device, the controller 320 and/or the input application 310 can proceed to render an input panel at one or more locations of a display device 360. When determining where on the display device 360 to render the input panel, the controller 320 and/or the input application 310 can use one or more default positions. One or more of the default positions can be defined by the controller 320 and/or the input application 310.

In one embodiment, if the sensor 330, the controller 320, and/or the input application 310 detect the holding position to include a first hand without a second hand, the controller 320 and/or the input application can identify the default position to be next to the detected holding position of the user. As a result, the controller 320 and/or the input application 310 can proceed to render the input panel next to the detected holding position of the user. By rendering the input panel next to the holding position of the user, the input panel can be positioned at a location readily apparent and accessible to the user.

In another embodiment, if the holding position was previously determined to include a first hand of the user and a second hand of the user, the controller 320 and/or the input application 310 can spot the input panel into a first portion and a second portion. The controller 320 and/or the input application 310 can render the first portion of the input panel next to the detected first hand of the user and render the second portion of the input panel next to the detected second hand of the user. By splitting the input panel into a first portion and a second portion and positioning each corresponding portion next to a hand position of the user, the user can use both of the user's hands when accessing the input panel and entering one or more inputs.

In other embodiments, when determining where to render the input panel, the controller 320 and/or the input application 310 can use one or more user specific input panel locations. A user specific input panel location can be defined by a user in response to the user accessing the input panel and repositioning the input panel to another location of the display device 360. The user can reposition the input panel by touching the input panel and dragging the input panel to another location of the display device 360.

In one embodiment, in response to the user accessing the device, the controller 320 and/or the input application 310 can attempt to identify the user and a holding position of the user to determine whether the user has a corresponding user specific input panel location. The user can be identified using an image of the user, a fingerprint of the user, and/or an input code of the user.

As noted above, one or more of the sensors 330 and/or a second sensor can include an image capture device and/or infrared device. A sensor 330 and/or a second sensor can capture an image of the user and/or capture the user's fingerprint. In another embodiment, the user can access the input panel and enter an input code corresponding to the user. The controller 320 and/or the input application 310 can compare the captured information to recorded information corresponding to the user.

In other embodiments, as illustrated in FIG. 3B, one or more sensors 330 can detect a user input pattern. A user input pattern can correspond to a location on the display device 360 where the user frequently enters one or more inputs. A sensor 330 can detect where on the display device 360 the user is entering one or more inputs and proceed to map the location and/or the pattern of the inputs. The controller 320 and/or the input application 310 can then access a database 305 and compare the user input pattern to one or more previously recorded user profiles. The database 305 can be stored on the device or on allocations accessible to the controller 320 and/or the input application 310.

The database 305 can list a corresponding user, a corresponding method to identify the user, a corresponding user holding position, a corresponding device orientation, and/or a corresponding user specific input panel location. As illustrated in the present embodiment, a corresponding method to identify the user can include a user input pattern. In another embodiment, the methods to identify the user can include an image of the user, a fingerprint of the user, and/or an input code of the user. In other embodiments, the database 305 can store additional data and/or information in addition to and/or in lieu of those noted above.

The controller 320 and/or the input application 310 can compare the user input pattern and/or any additional captured information from the user and compare it to entries within the database 305. If a match is found, the controller 320 and/or the input application 310 will further determine if the current holding position of the user and/or the current orientation of the device match the corresponding information in the entry. If a match is found, the controller 320 and/or the input application 310 will proceed to render and/or reposition the input panel to the listed user specific input panel location.

If no match is found, the controller 320 and/or the input application 310 can record the current input panel location, the method of identification for the user, the holding position of the user, and/or the orientation of the device. The controller 320 and/or the input application 310 can create a new entry for the user or modify an existing entry of the user.

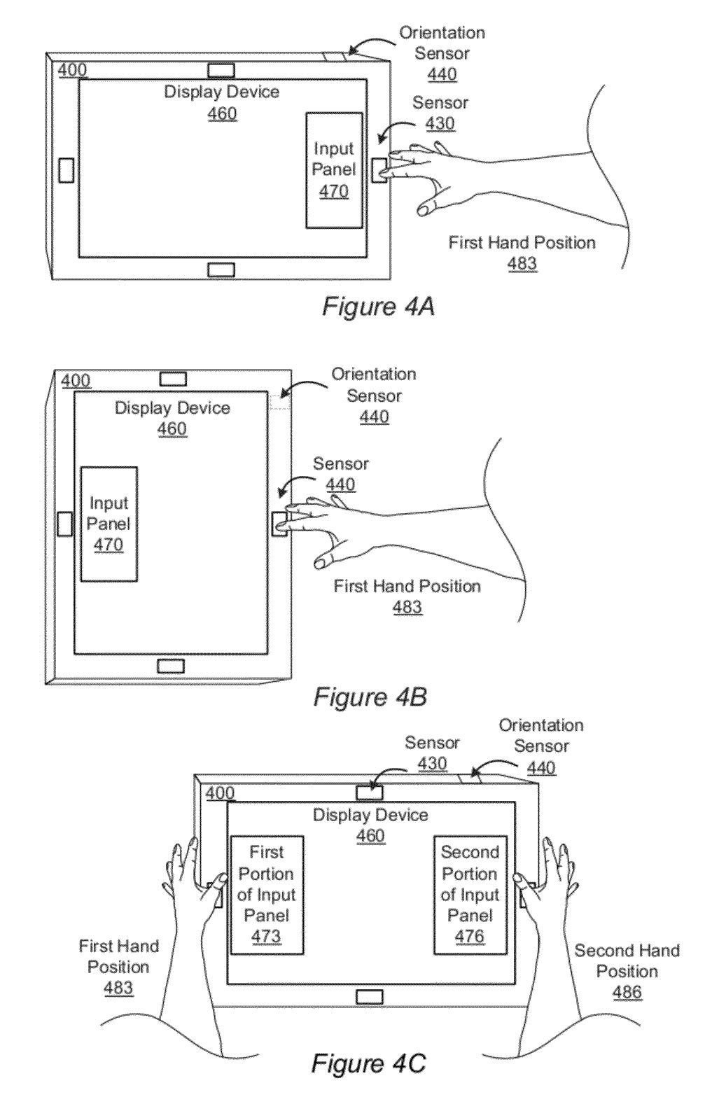

FIG. 4A, FIG. 43, and FIG. 4C illustrate an input panel 470 being rendered at one or more locations of a display device 460 according to an embodiment. As illustrated in FIG. 4A, one or more sensors 430 have detected a first hand position 483 of the user to be holding the device 400 at the right side of the device 400. Further, no second hand position is detected. As a result, a controller and/or an input application of the device 400 identify the holding position of the user to include a single hand of the user at the right center side of the device 400.

As shown in FIG. 4A, in response to detecting the holding position at the right center side of the device 400, the controller and/or the input application of the device 400 can proceed to render the input panel 470 at a the right center location of the display device 460, next to the detected holding position of the user. As noted above, rendering the input panel 470 can also include orienting the input panel 470 based on the detected orientation of the device 400. As illustrated in FIG. 4A, an orientation sensor 440 has detected the device 400 to be oriented in a landscape orientation.

In response, the controller and/or the input application can rotate and/or orient the input panel 470 such that the input panel 470 appears to be aligned with a horizontal view plane of the user while the device 400 is oriented in the landscape orientation. When aligned with the horizontal view plane of the user, the input panel 470 and any character, numbers, buttons, and/or images can be displayed to be upright and can be easily legible by the user.

In another embodiment, as illustrated in FIG. 4B, the input panel 470 can be rendered at another location of the display device 460. As shown in the present embodiment, one or more of the sensors 430 have detected a first hand position 483 of the user to be holding the device 400 at the right side of the device 400. As a result, a controller and/or an input application of the device 400 identify the holding position of the user to include a single hand of the user at the right center side of the device 400. Further, the orientation sensor 440 has detected the device 400 to be oriented in a portrait orientation.

As noted above, the input panel 470 can be rendered and/or repositioned to a location of the display device 460 in response to the controller and/or the input application identifying the user. The user can be identified using an image of the user, a fingerprint of the user, an input code of the user, and/or a user input pattern. In one embodiment, the controller and/or the input application have detected the user entering inputs at another location of the display device 460. In response the controller and/or the input application identify the user input pattern and determine that the input panel should be rendered or repositioned to another location of the display device 460.

As shown in the present embodiment, the controller and/or the input application of the device 400 can proceed to render the input panel 470 at the left center location of the display device 460, opposite of the detected holding position of the user. Further, the input panel 470 is oriented to be aligned with a horizontal view plane of the user in the portrait orientation. By rendering the input panel 470 at an opposite location on the display device 460, a non-dominant hand of the user can hold the device 400, while a dominant hand of the user can be used to access the input panel 470.

In another embodiment, as illustrated in FIG. 4C, one or more of the sensors 430 have detected a first hand position 483 of the user to be holding the device 400 at a left center position of the device 400. Additionally, one or more of the sensors 430 have detected a second hand position 486 of the user to be holding the device 400 at a right center position of the device 400. In response to determining that the holding position of the user includes a first hand position 483 and a second hand position 486, the controller and/or the input application proceed to render a first portion of the input panel 473 next the first hand position 483 of the user and render a second position of the input panel 476 next to a second hand position 486 of the user. Further, the input panel 470 is oriented to be aligned with a horizontal view plane of the user in the landscape orientation.

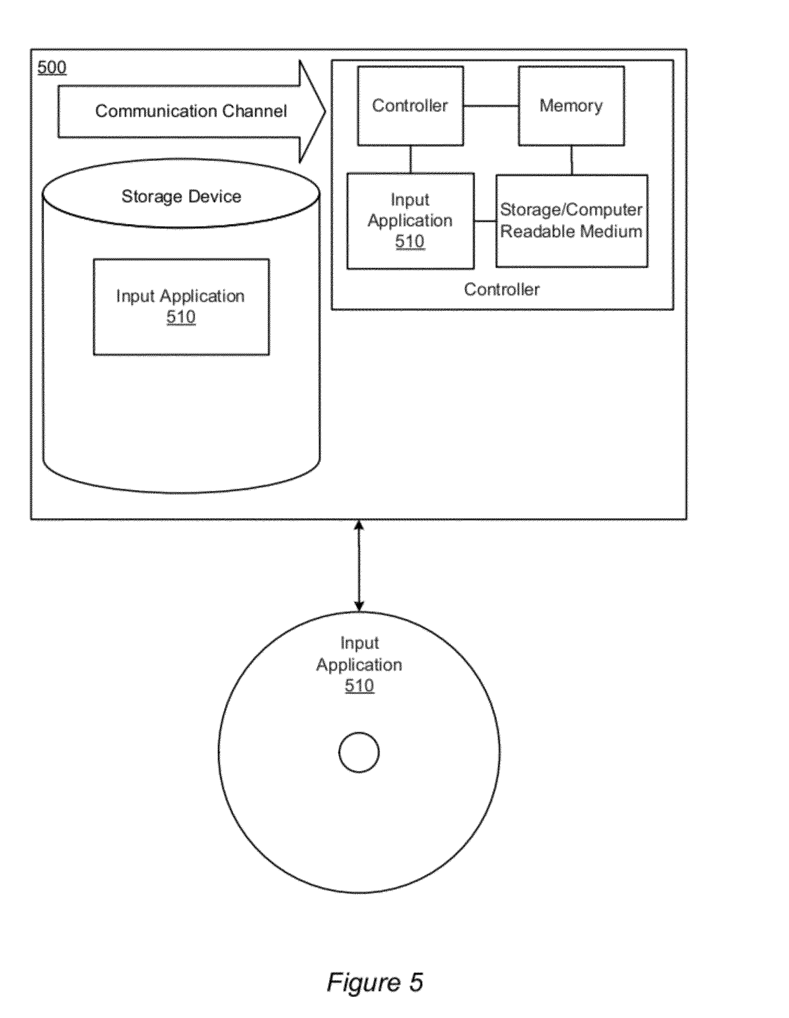

FIG. 5 illustrates an input application 510 on a device 500 and the input application 510 stored on a removable medium being accessed by the device 500 according to an embodiment. For the purposes of this description, a removable medium is any tangible apparatus that contains, stores, communicates, or transports the application for use by or in connection with the device 500. As noted above, in one embodiment, the input application 510 is firmware that is embedded into one or more components of the device 500 as ROM. In other embodiments, the input application 510 is an application or an operating system which is stored and accessed from a hard drive, a compact disc, a flash disk, a network drive or any other form of computer readable medium that is coupled to the device 500.

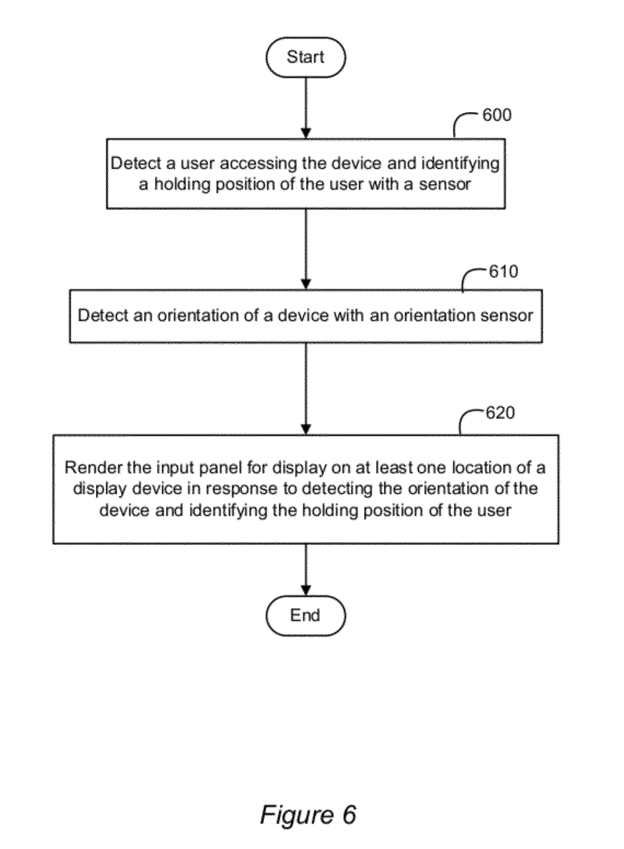

FIG. 6 is a flow chart illustrating a method for displaying an input panel according to an embodiment. The method of FIG. 6 uses a device with a controller, one or more sensors, an orientation sensor, a display device, a communication channel, and/or an input application. In other embodiments, the method of FIG. 6 uses additional components and/or devices in addition to and/or in lieu of those noted above and illustrated in FIGS. 1, 2, 3, 4, and 5.

As noted above, the input application is an application which can independently or in conjunction with the controller render an input panel on one or more locations of a display device. When determining where to render the input panel, one or more sensors of the device can initially detect user accessing the device and detect and/or identify a holding position of the user 600. The user can be any person who can access the device by holding the device.

One or more sensors can be coupled to one or more locations on a front of the device, a side of the device, and/or a rear of the device. In other embodiments, one or more sensors can be included in or integrated as part of the display device. In one embodiment, one or more sensors can include a touch panel, touch sensor, an image capture device, an infrared device, a proximity device, and/or any additional device which can detect and/or identify a holding position of the user.

As noted above, the holding position can include a first hand of the user holding the device. In another embodiment, the holding position can additionally include a second hand of the user holding the device. When detecting a holding position of the user, one or more sensors can determine where on the device one or more palms of the user is detected, where on the device fingers of the user are holding the device, and/or where on the device one or more arms of the user are holding or supporting the device.

As noted above, the device can additionally include an orientation sensor which can be utilized by the controller and/or the input application to detect an orientation of the device relative to one or more axes 610. In one embodiment, the orientation sensor includes a gyroscope and/or an accelerometer. Further, the orientation of the device can be based on the holding position of the device. Once the holding position of the device has been detected and the orientation of the device has been detected, the controller and/or the input application can proceed to render an input panel on one or more locations on the display device based on the holding position and the orientation of the device 620.

The input panel can be an interactive panel which the user can access to enter one or more inputs on the device. In one embodiment, the input panel can be or include an alpha numeric keyboard, an application panel, a navigation panel, and/or a media control panel. In other embodiments, the input panel can be or include additional forms of inputs which can be rendered at one or more locations of the display device.

When determining where to render the input panel, the controller and/or the input application can use one or more default locations, such as next to a holding position of the user. In another embodiment, if the holding position includes a first hand position and a second hand position, the controller and/or the input application can split the input panel to a first portion and a second portion. The first portion of the input panel can be rendered next to the first hand position of the user and the second portion of the input panel can be rendered next to the second hand position of the user.

In other embodiments, the controller and/or the input panel can attempt to identify the user and proceed to render and/or reposition the input panel to a user specific input panel location. Once the input panel has been rendered, the user can interact with the panel to enter one or more inputs for the device. In another embodiment, the user can reposition the input panel to create a new user specific input panel location.

In other embodiments, if the more than one user is accessing the device, the method disclosed can be repeated for each of the users accessing the device. In response, more than one input panel can be rendered for the corresponding users based on the users' detected corresponding holding position and the orientation of the device.

In one embodiment, a first user holding position can be at a first end of the device and a second user holding position can be at a second end of the device, opposite to the first user. In response, the controller and/or the input application can proceed to render a first user input panel at a first user location based on the first user holding position and the orientation of the device. Additionally, the controller and/or the input application can render a second user input panel at a second user location based on the second user holding position and the orientation of the device.

If any additional users are accessing the device, the controller and/or the input application can proceed to render additional user input panel at additional locations based on corresponding user holding positions and the orientation of the device. The method is then complete. In other embodiments, the method of FIG. 6 includes additional steps in addition to and/or in lieu of those depicted in FIG. 6.

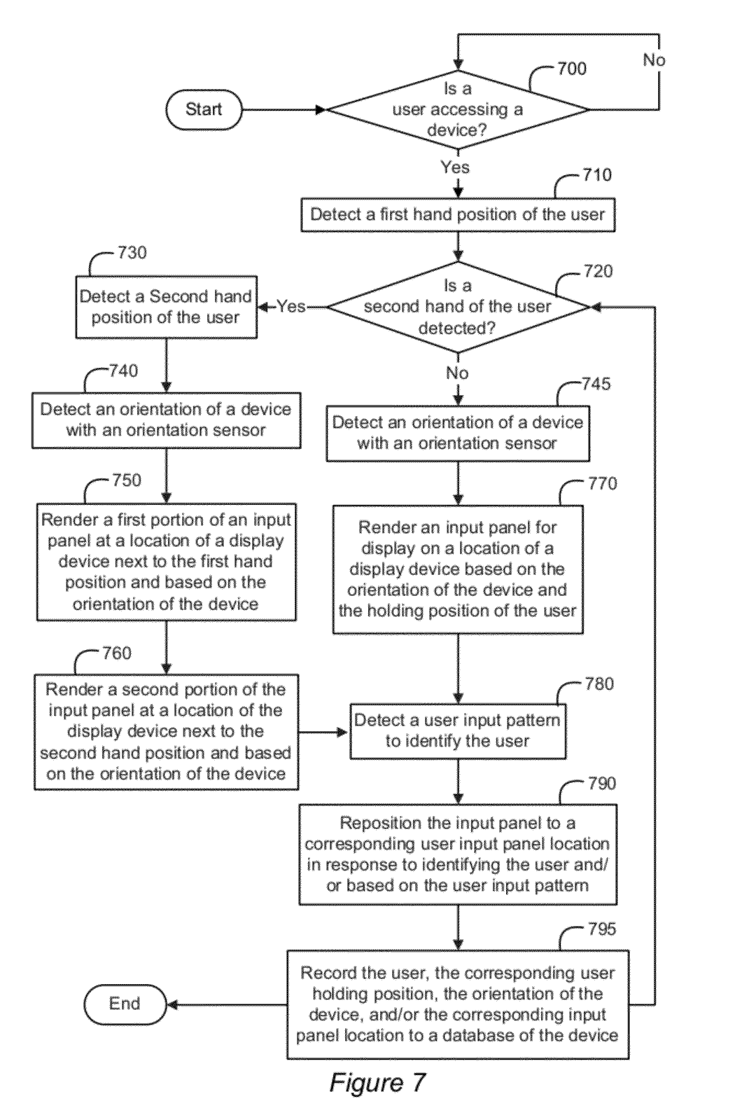

FIG. 7 is a flow chart illustrating a method for displaying an input panel according to another embodiment. Similar to the method disclosed above, the method of FIG. 7 uses a device with a controller, one or more sensors, a gyroscope, a display device, a communication channel, and/or an input application. In other embodiments, the method of FIG. 7 uses additional components and/or devices in addition to and/or in lieu of those noted above and illustrated in FIGS. 1, 2, 3, 4, and 5.

As noted above, one or more sensors of the device can initially determine whether a user is accessing the device 700. As noted above, the user can be accessing the device if the user is holding the device with one or more hands of the user and/or if the user is holding the device with an arm of the user. When determining whether the user holding the device, one or more of the sensors can detect one or more palms of the user, side by side fingers of the user, and/or one or more arms of the user.

If no user is detected to be accessing the device, one or more sensors can continue to detect whether a user is accessing the device 700. If a sensor detects a user accessing the device, one or more of the sensors can proceed to detect a holding position of the user. As noted above, when detecting a holding position of the user, one or more of the sensors can detect a first hand position of the user holding the device 710. When detecting the first hand position, a sensor can detect where on the device the user's first hand is holding the device. The sensor can detect where on the device a palm of the user is located, where on the device side by side fingers are located, and where on the device an arm of the user is located.

Once the first hand position has been detected, the controller and/or the input application can proceed to determine whether the user is using a second hand to hold the device. One or more of the sensors can detect whether second hand of the user is holding the device 720. Similar to the method above, a sensor can detect for any additional palm, arm, and/or side by side fingers.

If a second hand position is not detected, the controller and/or the input application can determine that the holding position of the user includes a first hand position. As noted above, the device can include an orientation sensor. The orientation sensor can be utilized in conjunction with the controller and/or the sensor to detect an orientation of the device 745. In one embodiment, the orientation sensor will detect the orientation based on the holding position of the user. In other embodiments, the orientation sensor can detect the orientation of the device while one or more of the sensors detect the holding position of the user.

Once the holding position of the user and the orientation of the device have been detected, the controller and/or the input application can proceed to render an input panel on a location of the display device based on the holding position of the user and the orientation of the device 770. As noted above, if the holding position includes a first hand position without a second hand position, the controller and/or the input application can determine to render the input panel next to the detected holding position of the user.

In another embodiment, if a second hand position was previously detected, one or more of the sensors can detect the second hand position by detecting where on the device another palm of the user is located, where on the device additional side by side fingers are located, and where on the device another arm of the user is located 730. Once the second hand position has been detected, the orientation sensor can proceed to detect the orientation of the device 740.

In one embodiment, if the holding position includes a first hand position and a second hand position, the controller and/or the input application can determine to split the input panel into one or more portions. The controller and/or the input application can render a first portion of the input panel at a location of the display device next to the first hand position and orient the first portion of the input panel based on the detected orientation of the device 750.

The controller and/or the input application can then proceed to render a second portion of the input panel at a location of the display device next to the second hand position and proceed to orient the first portion of the input panel based on the detected orientation of the device 760. Once the input panel has been rendered on one or more locations of the display device, the user can access the input panel and enter one or more inputs. In another embodiment, the controller and/or the input application can attempt to identify the user. When identifying the user, a sensor can capture an image of the user, a fingerprint of the user, and/or a user input code from the user for the controller and/or the input application to identify the user.

In another embodiment, the user can be identified by detecting a user input pattern from the user 780. As noted above, a user input pattern corresponds to where on the display device the user frequently accesses to enter one or more inputs and/or a pattern of inputs. The controller and/or the input application can map the detected location and/or pattern of inputs and compare it to one or more entries in a database. As noted above, the database can be stored on the device or on one or more locations accessible to the controller and/or the input application. Additionally, one or more of the entries can correspond to one or more users. The entries can list the corresponding user, a corresponding input pattern, a corresponding holding position of the user, a corresponding orientation of the device, and a user specific input panel location.

If one or more entries match the previously detected information, the controller and/or the input application will determine that a match is found and proceed to render and/or reposition the input panel to the user specific input panel location based on the user input pattern listed in the database 790. If the user has a user specific input panel location, the controller and/or the input application will determine that the user previously positioned or moved the input panel to the user specific input panel location. In one embodiment, the corresponding entry and the database can be updated to record any changes to the information corresponding to the user 795.

In another embodiment, if no match is found, the controller and/or the input application can determine whether the user has moved the input panel from a default location. If the input panel has been moved, the controller and/or the input panel can proceed to create a new entry or edit an existing entry for the user with the corresponding the user input pattern, the holding position, the orientation of the device, and the current input panel location. In one embodiment, the method is then complete.

In another embodiment, if the holding position of the user previously included a first hand position without a second hand position, one or more sensors can continue to determine whether a second hand of the user is detected 720 and one or more steps disclosed above can be repeated. In other embodiments, the method of FIG. 7 includes additional steps in addition to and/or in lieu of those depicted in FIG. 7.

What is claimed is:

1. A device comprising:
a sensor to detect a holding position of a user of the device;
an orientation sensor to detect an orientation of the device;
a display device to display an input panel for the user to interact with; and
a controller to render the input panel on at least one location of the display device based on the holding position of the user and the orientation of the device.

2. The device of claim 1 wherein the sensor is included in the display device.

3. The device of claim 2 wherein the sensor detects an input from the user if the user accesses the input panel.

4. The device of claim 1 wherein the sensor is coupled to at least one of a side of the device and a rear of the device.

5. The device of claim 4 further comprising a second sensor to detect an input from the user if the user accesses the input panel.

6. The device of claim 5 where the second sensor includes an image capture device.

7. The device of claim 1 wherein the sensor detects at least one of a first hand position and a second hand position of the user when detecting the holding position of the user.

8. The device of claim 1 wherein the input panel includes at least one from the group consisting of an alpha numeric keyboard, a navigation panel, an application control panel, and a media player panel.

9. A method for displaying an input panel comprising:
detecting a user accessing the device and identifying a holding position of the user with a sensor;
detecting an orientation of a device with an orientation sensor; and
rendering the input panel for display on at least one location of a display device in response to detecting the orientation of the device and identifying the holding position of the user.

10. The method for displaying an input panel of claim 9 wherein identifying a holding position of the user includes the sensor detecting a first hand position of the user.

11. The method for displaying an input panel of claim 10 wherein identifying a holding position of the user includes the sensor detecting a second hand position of the user.

12. The method for displaying an input panel of claim 10 further comprising rendering the input panel for display at a location of the display device next to the first hand position.

13. The method for displaying an input panel of claim 10 further comprising rendering the input panel for display at a location of the display device opposite to the first hand position.

14. The method for displaying an input panel of claim 11 further comprising rendering a first portion of the input panel for display at a location of the display device next to the first hand position.

15. The method for displaying an input panel of claim 14 further comprising rendering a second portion of the input panel for display at a second location of the display device next to the second hand position of the user.

16. A computer readable medium comprising instructions that if executed cause a controller to:
detect an orientation of a device with an orientation sensor in response to a user accessing the device;
identify a holding position of the user with a sensor; and
render an input panel at a location of a display device based on the orientation of the device and the holding position of the user.

17. The computer readable medium comprising instructions of claim 16 wherein the controller detects a user input pattern to identify a user in response to the user entering at least one input.

18. The computer readable medium comprising instructions of claim 17 wherein the controller repositions the input panel to a corresponding user input panel location based on the user input pattern.

19. The computer readable medium comprising instructions of claim 18 wherein the controller records to a database at least one from the group consisting of the user, a user holding position, an orientation of the device, and the corresponding input panel location to a database of the device.

20. The computer readable medium comprising instructions of claim 19 wherein the database lists at least one from the group consisting of a user, a corresponding user holding position, an orientation of the device, the corresponding user input pattern, and the corresponding user input panel location.
